(19) United States
(12) Patent Application Publication
(10) Pub. No.: US 2011/0155076 A1
(43) Pub. Date: Jun. 30, 2011

(54) HAND & LEASH COVERING

(76) Inventor: Patricia M. Charette, Beverly, MA (US)

(21) Appl. No.: 12/978,606

(22) Filed: Dec. 26, 2010

Related U.S. Application Data
(60) Provisional application No. 61/290,122, filed on Dec. 24, 2009.

(51) Int. Cl. A01K 27/00; A41D 19/01

(52) U.S. Cl. 119/795; 2/158

(57) ABSTRACT

The present invention relates to a device to be worn over the hand of an individual while walking an animal with a retractable leash or lead. The leash mitt includes a covering having a front end, a back end, a top end, a bottom end, an outside surface and an inside surface, wherein the covering defines a pocket to house the hand of an individual and a retractable leash or lead; a first opening at the bottom end, wherein the opening has a recloseable member and has a size between about 6 inches and about 10 inches, wherein the recloseable member closes a portion of the opening to thereby leaving a point of extrusion for the leash; and a second opening at the front end of the covering and defined by a lip having a size to receive the hand of the individual, wherein the lip has a securing means.

### RELATED APPLICATION

This application claims the benefit of U.S. Provisional Application No. 61/290,122, filed Dec. 24, 2009, entitled “Hand & Leash Covering” by Patty Charette.

The entire teachings of the above application are incorporated herein by reference.

### BACKGROUND OF THE INVENTION

Various types of gloves or mittens are used to keep an individual's hands warm while walking a dog. However, it is often difficult for an individual with conventional gloves or mittens on to hold an animal leash or lead, especially a retractable one, without compromising warmth, comfort and flexibility.

Accordingly, a need exists for a mitt to be worn by an individual that is flexible, easy to put on and remove, and encloses a retractable leash as well as the hand of an individual who is holding the leash. A further need exists for such a mitt that also allows the user to connect and disconnect the leash without having to remove the mitt. Yet, another need exists for matching accessories for an individual and pet consisting of hats, ear warmers, earmuffs, neck warmers, scarves, gloves and socks.

### SUMMARY OF THE INVENTION

The present invention also includes leash mitts, systems, kits and methods for keeping an individual's hands warm while walking an animal with a retractable leash or lead.

The present invention relates to a leash mitt to be worn over a hand of an individual wherein the hand holds a retractable leash or lead. The leash mitt includes a covering having a front end, a back end, a top end, a bottom end, an outside surface and an inside surface, wherein the covering defines a first pocket to house the hand of an individual and a retractable leash or lead; a first opening at the bottom end, wherein the opening has a recloseable member and has a size between about 6 inches and about 10 inches, wherein the recloseable member closes a portion of the opening to thereby leave a point of extrusion for the leash; and a second opening at the front end of the covering and defined by a lip having a size to receive the hand of the individual, wherein the lip has a securing means (e.g., a securer). The first pocket that houses the hand of the individual and the leash, in an embodiment, has a length ranging from about 10 inches to about 16 inches, and a height ranging from about 6 inches to about 10 inches. The recloseable member of the first opening can be e.g., a zipper, a series of snaps, a fastener, a strap, a buckle, a trap-lock, a series of buttons, a series of hooks, an elastic member, a tie, a clip, a drawstring & cord lock, a hook-to-hook arrangement, a hook & loop arrangement, a bungee cord & cord lock, a magnet, a slide, a series of clips or any combination thereof. The securing means can be secured or sewn into the lip to accommodate various sizes of individual's wrists as well as seal warm air inside the mitt. The securing means can be e.g., a series of snaps, a fastener, a strap, a buckle, a series of buttons, a series of hooks, an elastic member, a tie, a clip, a series of clips or any combination thereof. The leash mitt of the present invention can further includes an adjustable means (e.g., an adjustor) for accommodating various sizes of an individual's hand and/or leashes. Examples of adjustors include a series of snaps, a fastener, a buckle, a series of buttons, a series of hooks, a clip, a series of clips or any combination thereof. In an embodiment, the leash mitt and/or the non-leash mitt or glove is made from a flexible material such as e.g., polyethylene, polyurethane coated nylon, polyester, cotton, fleece, terry cloth, leather, nylon, polypropylene, wool, yarn, sheepskin, Tyvek® material, rayon, a synthetic material, an elastic material, or any combination thereof. In an embodiment, the leash mitt and/or non-leash mitt or glove is lined with an insulating material. Insulating material includes, for example, cotton, fleece, terry cloth, leather, nylon, down, polypropylene, wool, yarn, sheepskin, a synthetic material, an elastic material, or any combination thereof. In one aspect of the invention, the leash mitt and non-leash mitt/glove match in color, pattern, texture, or any combination thereof. The leash mitt can be made from the same material or same piece of material, or from different pieces of different material. The leash mitt of the present invention can further include a stopper, locking mechanism or divider at the point of extrusion to prevent the recloseable member from unwanted re-opening and/or to maintain the point of extrusion. The leash mitt can have a second pocket sewn to the outside or inside surface of the mitt for holding items (e.g., keys, flashlight, plastic bags, etc.).

The present invention includes systems or kits that have a leash mitt, as described herein, a non-leash mitt or glove to cover the hand of the individual that is not holding a leash or lead, and/or the leash itself.

The present invention pertains to methods for walking a dog with a retractable leash or lead with the leash mitt described herein. The methods include inserting an individual's hand into the first pocket through the second opening; inserting the retractable leash or lead into the first opening; gripping the grip of the leash; and extending the second end of the leash through the first opening; engaging the recloseable member to essentially close the first opening, except for the point of extrusion of the leash; and walking the dog. The methods include disconnecting and reconnecting the leash to the dog without removing the individual's hand from the leash mitt. In another embodiment, the methods can further include steps to remove the leash mitt of the present invention. The steps include engaging the recloseable member to open the first opening; retracting the leash; and removing the retractable leash or lead from the leash mitt.

The present invention has several advantages. The leash mitt of the present invention allows an individual to easily place an enclosure around their entire hand while holding a retractable leash or lead without compromising warmth, comfort and flexibility. The present invention also allows an individual to easily place the retractable leash or lead into the enclosure. Specifically, an individual can secure the retractable leash or lead to the animal and then place the leash into the leash mitt. Alternatively, the individual can place the retractable leash or lead into the leash mitt and then secure the leash to the animal. Accordingly, the individual can easily place the retractable leash or lead into the mitt regardless of the manner in which the leash is secured to the animal. The leash mitt of present invention also allows the user to disconnect and reconnect the leash without having to remove his or her hand from the leash mitt. Furthermore in certain embodiments, the present invention provides individual's with a pair or set of the mitt and also matching sets for animals (e.g., hats, ear warmers, earmuffs, neck warmers, scarves, gloves, socks, or any combination thereof).

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a schematic of a side view of the leash mitt of the present invention.

FIG. 1B is a schematic of the other side of the leash mitt showing the second pocket.

FIG. 2. is a schematic of the bottom view of the bottom end of the leash mitt showing the first opening closed.

FIG. 3. is a schematic of the bottom view of the bottom end of the leash mitt showing the first opening opened.

FIG. 4. is a schematic of the front view of the front end of the leash mitt showing the an elastic member as the securing means.

FIG. 5. is a schematic of the top view of the top end of the leash mitt.

FIG. 6. is a schematic of the rear view of the back end of the leash mitt.

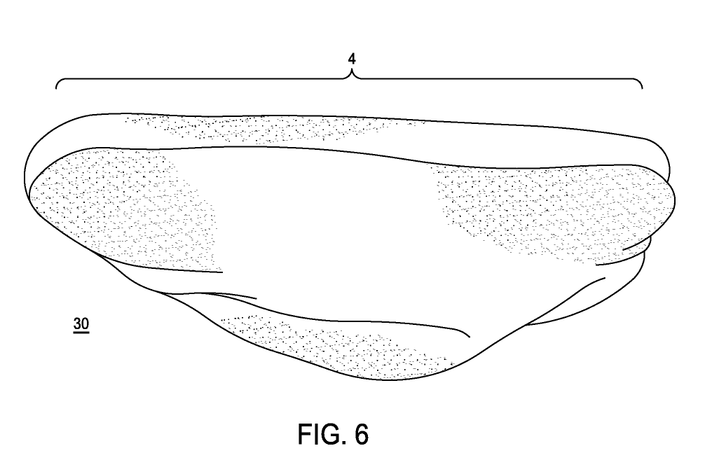

### DETAILED DESCRIPTION OF THE INVENTION

A description of preferred embodiments of the invention follows.

The present invention relates to a system for keeping an individual's hands warm while walking a dog with a retractable leash or lead. The present invention pertains to a leas mitt that receives and covers the retractable leash as well as the individual's hand, and also allows extrusion of the leash while walking the dog. A retractable leash has a base having a retractable mechanism for retracting the leash, and the leash itself. The leash has a first end that attaches to the retractable mechanism, and a second end that attaches to the dog's collar or harness.

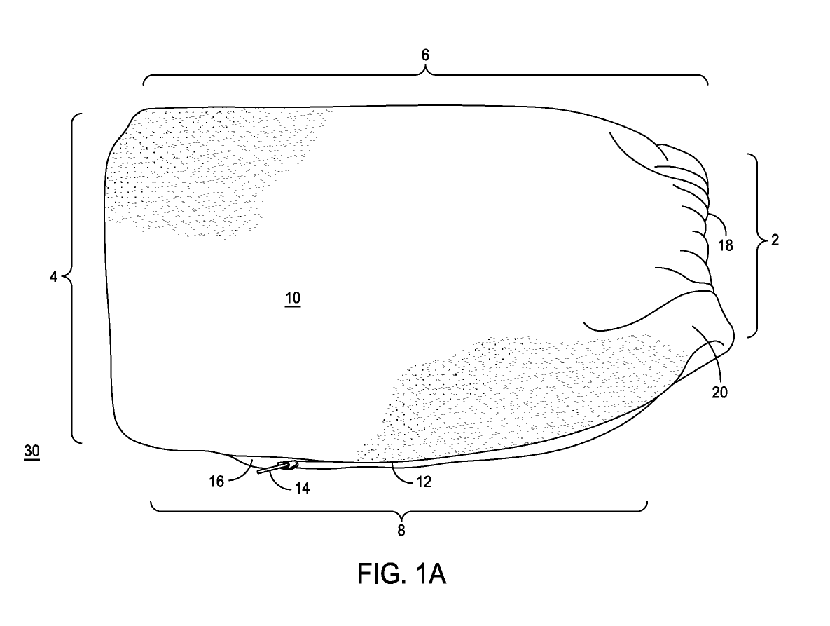

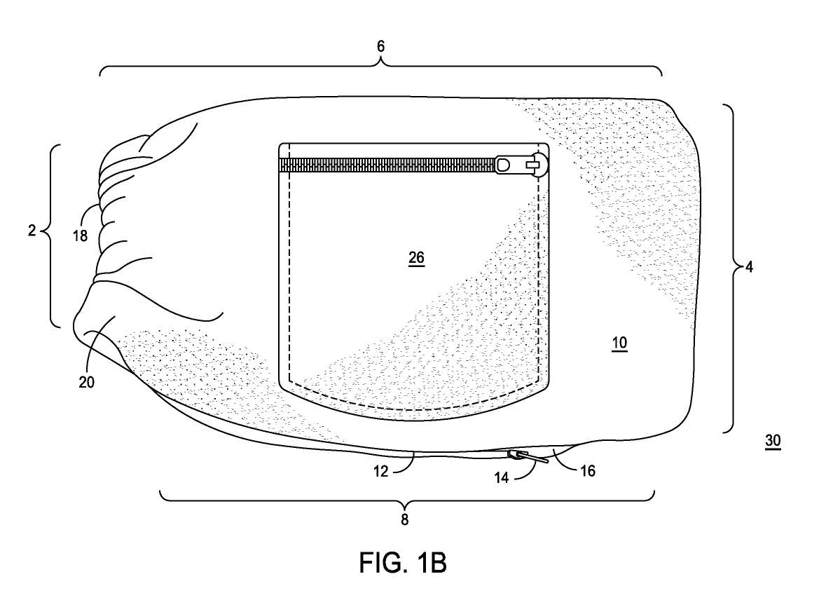

Referring to FIG. 1A, a side view of leash mitt 30 is shown. The leash mitt is referred to herein as a leash (e.g., retractable leash) and hand covering, and the terms are used interchangeably. FIG. 1A shows front end 2, back end 4, top end 6 and bottom end 8. The leash mitt has two openings, first opening 12 and second opening 18. First opening 12 allows leash mitt 30 to receive a retractable leash, and second opening 18 allows leash mitt 30 to receive the user's hand.

FIG. 1B shows the other side of leash mitt 30 including pocket 26. Pocket 26 can be sewn or otherwise attached to the inside or outside of leash mitt 30. Pocket 26 can have any shape including an irregular shape, a square shape, a curved shape, and the like. Pocket 26 can have a length that ranges between about ½ inch to about 3 inches (e.g., about 1 inch). Pocket 26 can be used to hold accessories (e.g., bags, keys, a dog treat, cell phone, etc.). Pocket 26 can further include a recloseable opening using devices described herein.

The size of the leash mitt can range and vary to accommodate the shape of the retractable leash and the size of the user's hand. Many retractable leashes have a rectangularly-shaped base, and as such, the shape of the leash mitt of the present invention can have essentially a rectangular shape, except for the front end and/or the bottom end where the openings exist. However, the leash mitt can have any shape including an irregular shape, a square shape, a curved shape, and the like. Similarly, the size of the leash mitt includes a length (e.g., the distance between the front and back ends) that ranges between about 10 inches to about 16 inches (e.g., about 11 inches). The leash mitt also has a height (e.g., from the top end to the bottom end) that ranges between about 6 inches to about 10 inches (e.g., about 7 inches). The leash mitt can have an overall thickness of about ¼ inch to about 2 inches (e.g., about ½ inch). The leash mitt of the present invention, in an aspect, can be sold in small, medium and large sizes.

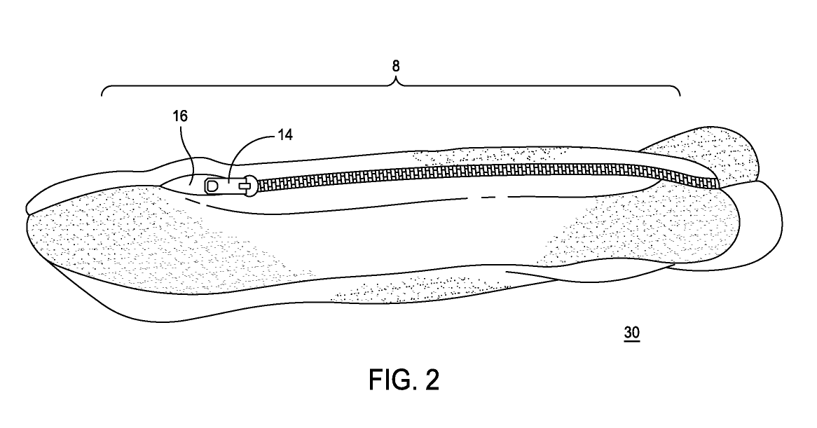

With respect to FIG. 2, bottom end 8 having the first opening for receiving the retractable leash is shown. The first opening includes zipper 14, stopper (not shown) and point of extrusion 16 of the end of the leash. In addition to a zipper, the recloseable member of the first opening can be any fastener that allows the opening to be opened and/or closed. Examples of such members include a zipper, a series of snaps, a fastener, a strap, a buckle, a trap-lock, a series of buttons, a series of hooks, an elastic member, a tie, a clip, a drawstring & cord lock, a hook-to-hook arrangement, a hook & loop arrangement, a bungee cord & cord lock, a magnet, a slide, a series of clips or a combination thereof. Recloseable members known or developed in the future can be used so long as the first opening can be opened and closed. These recloseable members can be obtained or purchased through commercially available means. Recloseable members are commercially available, and can be obtained, for example from 3M Corporation (St. Paul, Minn.).

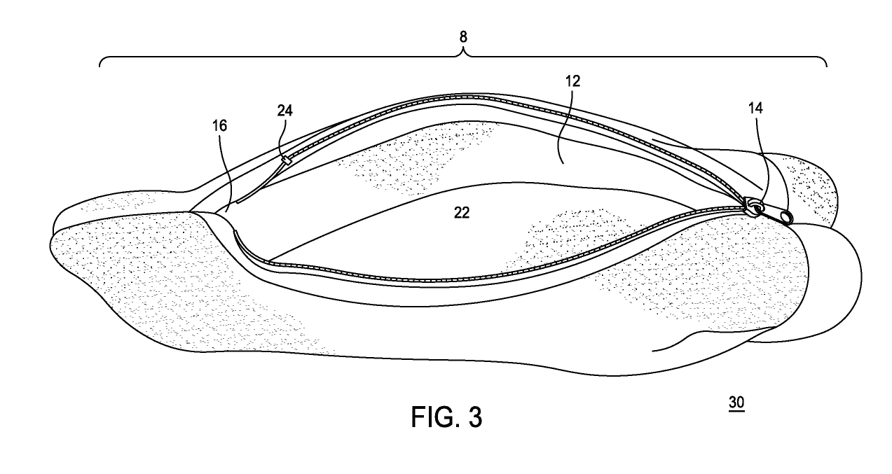

FIG. 2 also shows point of extrusion 16 of the leash. Between the stopper and one end of first opening 12 (also see FIG. 3) is another opening through which the leash end extrudes. Once the retractable leash is received by the leash mitt, the end of the leash is pulled through the first opening. The first opening is closed by the recloseable member, and the leash end extrudes from the leash mitt. Accordingly, the retractable leash and the user's hand remain in the leash mitt and shield or insulate from cold weather, while the leash is connected to the dog's collar or harness. The point of extrusion of the leash can be created by not closing the first opening fully, as shown in FIGS. 2 and 3, to thereby leave a point of extrusion. In the case of a zipper for use as a recloseable means, a stopper can be placed at the point of extrusion to prevent the zipper from fully closing the first opening. Stopper 24 can be any device that restricts recloseable member from moving past a desired point or from fully closing. Stoppers can be made from plastic, metal, brass or any combination thereof and can be obtained, e.g., from Hangzhou Chuangfa Zipper Co., Ltd. (Hangzhou, China). Stoppers now known or later developed can be used with the present invention. Similarly, in the case of other fasteners, the point of extrusion will be devoid of any such fastener to thereby prevent the fastener from fully closing the first opening and leaving a point for the leash to extrude.

Additionally, the recloseable member can be locked into a “closed” position to prevent the leash, when in use, from accidentally or unwantedly re-opening the recloseable member. Accordingly, the recloseable member can be locked into position (e.g., with an additional fastener or member, as defined herein) or an additional support member or divider can be present between the point of extrusion and the end of the recloseable member to prevent unwanted opening of the member. For example, in the case in which the recloseable member is a hook and loop fastener (e.g., VELCRO®), a strap or guard can be inserted between the hook and loop fastener and the point of extrusion, and fastened to itself or to the leash mitt to secure the closing e.g., to prevent the force of the leash, when in use to reopen the recloseable member accidentally.

In another embodiment, the first opening can be fully closed by the recloseable member, and the point of extrusion can be a separate opening through which the leash is extracted. The point of extrusion is an opening that is large enough to receive the leash. Generally, the point of extrusion has a length that is wider than the width of the leash, and for example, can range between about a ½ inch and 3 inches. The point of extrusion allows the user to pull the leash out of the retractable leash base and attach the least to the dog without removing his/her hand from the leash mitt.

Referring to FIG. 3, first opening 12 has an opening large enough to receive a retractable leash. For example, the first opening can have a length ranging from about 6 inches and about 10 inches. First opening 12 is of a size adequate to allow the individual to place the retractable leash or lead into first opening 12 either before securing the dog to the leash or after securing the dog to the leash. First opening 12 allows an individual to insert the retractable leash into first opening n12 without having to detach the leash from the dog while keeping his/her hand inside the leash mitt.

In FIG. 3, inside surface 22 is shown. The inner surface and/or the outer surface can be made of the same piece of material, different pieces of the same material, different pieces of different types of materials, or any combination thereof. In an embodiment, the inner surface includes a lining of a material designed to keep the individual's hand warm. In an aspect, the material used for the leash mitt is preferably constructed from washable and flexible material. The material can be any material known or later developed. In an aspect, a flexible material provides mobility to conform to fit over a variety of hand sizes. Flexible material is material that allows movement of the fabric. In an embodiment, the material can be adjusted and/or stretched to accommodate various sizes and shapes. Flexible material is generally either thin-walled material that can be compacted or folded. Flexible materials are known in the art, and are obtainable by a skilled artisan. Additionally, the material used to make the present invention can be a stretchable material exhibiting elastic properties (e.g., Spandex). In an aspect, the material can be both flexible and stretchable. Examples of fabrics that can be used to make the leash mitt of the present invention include polyethylene, polyurethane coated nylon, polyester, cotton, fleece, terry cloth, leather, nylon, polypropylene, wool, yarn, sheepskin, Tyvek® material, rayon, a synthetic material, an elastic material, or any combination thereof. Such materials can be obtained, e.g., from Polartec, LLC (Lawrence, Mass.). Flexible material can be used to construct the entire leash mitt of the present invention or portions of it.

Additionally, the outer surface can be a wind resistant and/or liquid resistant material. A wind resistant material is one that reduces or prevents wind to pass through the mitt. A liquid-resistant material refers to material that allows less liquid to permeate the fabric (e.g., less porous) than one that is not liquid-resistant. Such materials are known in the art and can be obtained from a number of manufacturers. Examples of such wind resistant or liquid resistant materials include polyethylene, polyurethane coated nylon, and polyester. Such fabrics can be obtained, e.g., from Seattle Fabrics (Seattle, Wash.) or Jiunn-Jang (Tien-Chung, Taiwan). Wind resistant or liquid-resistant materials now known or later developed can be used with the present invention.

The material used for the leash mitt of the present invention can also be soil-resistant. Soil-resistant material is material that fully prevents, or reduces soil or debris from permeating the fabric. Soil-resistant material includes, for example, cotton, polyethylene, Tyvek® material, rayon, and nylon. Such fabrics are known in the art and can be obtained from a number of manufacturers including Beacon Fabric & Notions (South Pasadena, Fla.). Soil-resistant materials now known or later developed can be used with the present invention. Materials that are soil-resistant and liquid-resistant can be used with the present invention.

The leash mitt of the present invention can further include one or more reflective pieces or a reflective surface. In the case of reflective pieces, the pieces can be mounted on at least one side of the leash mitt. A reflective surface can also be provided by adding an additional outside layer of reflective material. In an embodiment, the reflective surface is sufficiently flexible to conform to the contours of the individual's hand and not restrict the individual's range of motion and position. The reflective material can include an additional reflective backing that increases the amount of light reflected off of the leash mitt. The reflective material can be colored, such as florescent yellow, orange or red, and typically includes a highly reflective backing covered by a transparent or translucent clear or colored layer. Such fabrics can be obtained from a number of manufacturers including e.g., Reflexite North America (New Britain, Conn.) or 3M (St Paul, Minn.) which makes a variety of flexible, reflective materials including SCOTCHLITE® material. Reflective materials known in the art or developed in the future can be used with the present invention.

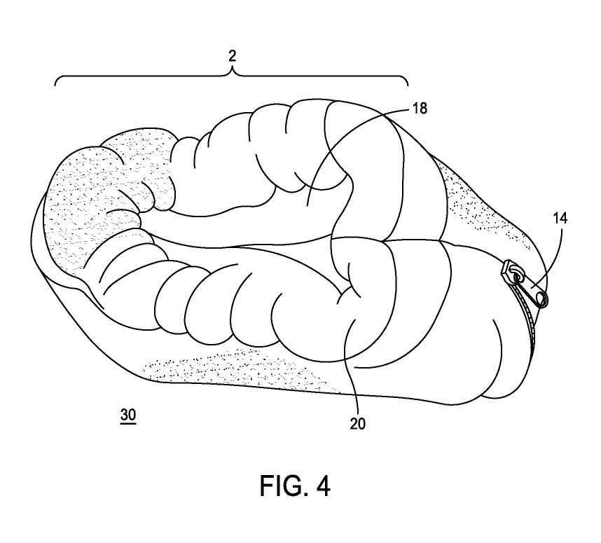

In reference to FIG. 4, front end 2 is shown. The front end of leash mitt 30 has second opening 18 for receiving an individual's hand. The second opening has lip 20. Lip 20 includes an elastic member as a securing means sewn within it. Although in this embodiment, the elastic member is sewn in, the member can be placed on top, or otherwise integrated with the edge defined by the second opening. In a preferred embodiment, the second opening is enclosed at the user's hand at the wrist or lower arm. The opening can be tightened or snug around the user's wrist by use of a securing member such as an elastic member to accommodate various sizes of individual's wrists as well as to seal in warm air as shown in FIG. 4. In addition to an elastic member, the securing member can be substituted with straps, snaps, fasteners, buckles, buttons, hooks, ties, clips, zippers, drawstring & cord lock arrangements, hook & loop arrangements, and combinations thereof. Any securing member that is known or later developed can be used so long as the securing member essentially brings the material around the user's wrist.

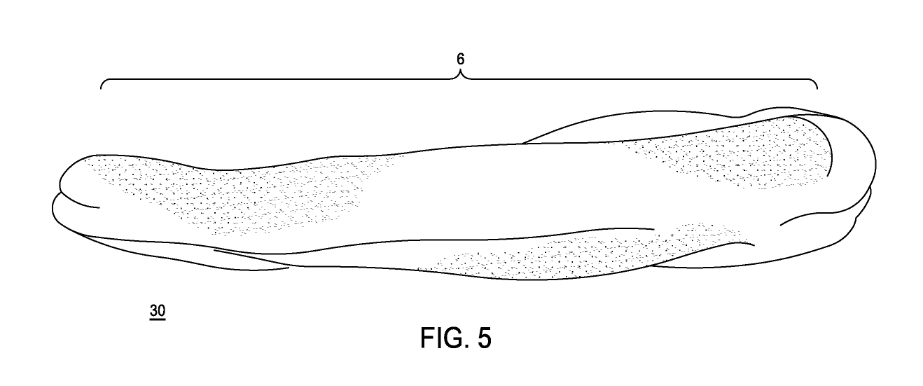

FIGS. 4 and 5 show the top end and the back end, respectively. Leash mitt 30 is made from a single piece of material and a seam is shown at the back end. However, as described herein a single piece or several pieces of material can be used. Additionally, the pieces or pieces can be sewn together, glued, molded, or otherwise attached using methods known or developed later.

The leash mitt of the present invention can further include an adjustable means (e.g., an adjustor) for accommodating various sizes of an individual's hand and various retractable leash sizes. In particular, the length of the leash mitt can be adjusted either to make it larger or smaller depending on the size of the individual's hand, the size of the leash or both. The leash mitt of present invention can be adjusted by a length that ranges between about ½ inch and about 8 inches. In an embodiment, the leash mitt of the present invention can be adjusted by one, two or more sizes. The adjustable means can be secured on the inside or outside of leash mitt and can include e.g., a zipper, a series of snaps, a fastener (e.g., a hook and loop fastener), a strap, a buckle, a trap-lock, a series of buttons, a series of hooks, a clip, a drawstring & cord lock, a hook-to-hook arrangement, a hook & loop arrangement, a bungee cord & cord lock, a magnet, a series of clips or a combination thereof. The user can expand or contract the length of the leash mitt by engaging the adjustor. In a preferred embodiment, the leash mitt of the present invention is adjusted by means of a series of snaps secured to the outside of the leash mitt near the back end. In another embodiment, the leash mitt of the present invention can be adjusted by means of a bungee cord & cord lock wherein the user engages the bungee cord and the cord lock to essentially cinch or reduce the length of the leash mitt.

The present invention includes a system having the leash mitt, as shown and described, along with another mitt and/or glove for the hand that is not using the leash. The additional or second mitt and/or glove, in a preferred embodiment, match the leash mitt of the present invention in color, fabric, texture or combination thereof. In yet another embodiment the leash mitt can be modified to accommodate both hands of the individual by increasing the size of the second opening.

The present invention further relates to a kit having the leash mitt, and one or more of the following: a second mitten or glove, and a retractable leash, a matching accessory (e.g., sweater for the dog, hats, ear warmers, earmuffs, neck warmers, scarves, socks and the like) or any combination thereof.

Methods of walking a dog using the leash mitt described herein are further included in the present invention. The methods include putting on the leash mitt. The methods involve inserting the user's hand into the pocket through the second opening; and inserting the retractable leash or lead into the first opening of the leash mitt, as described herein. The method includes gripping the grip of the leash, extending the end of the leash through the first opening, and then engaging the recloseable member to essentially close the first opening, except for the point of extrusion of the leash. The first opening is of a size adequate to allow the individual the ease of placing the retractable leash or lead into the opening either before securing the dog to the leash or after securing the dog to the leash. Thus, it does not matter the manner in which the dog is secured to the retractable leash, although it is preferred to insert the leash into the first opening after the leash is secured to the dog. When closed, the leash extrudes through the point of extrusion. The leash can be disconnected from the dog and then reconnected while the user's hand remains in the leash mitt of the present invention. The design of the leash mitt allows the user to keep their hand warm and still connect, disconnect and reconnect the leash to the dog. In the case in which the leash mitt includes a locking mechanism, the user can engage the mechanism to prevent the recloseable opening from unwanted opening while walking the dog.

After walking the dog, the user can remove the leash mitt. Accordingly, the methods include engaging the recloseable member to open the first opening, retracting the leash, removing the retractable leash or lead from the leash mitt, removing the user's hand from the leash mitt and finally removing the retractable leash or lead from the dog. The present invention allows the individual the ease of inserting and removing the retractable leash into the first opening without having to detach the leash from the dog.

An additional embodiment includes the leash mitt of the present invention having one or more pockets or pouches to hold accessories (e.g., bags, keys, a dog treat, cell phone, etc.). The additional pocket or pouch can be sewn or otherwise attached to the inside or outside of the leash mitt. The additional or second pocket has also includes as second recloseable member, which are described herein.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A leash mitt to be worn over a hand of an individual wherein the hand holds a retractable leash or lead, the leash mitt comprises:
a. a covering having a front end, a back end, a top end, a bottom end, an outside surface and an inside surface, wherein the covering defines a first pocket to house the hand of an individual and a retractable leash or lead;
b. a first opening at the bottom end, wherein the opening has a recloseable member and has a size between about 6 inches and about 10 inches, wherein the recloseable member closes a portion of the opening to thereby leaving a point of extrusion for the leash; and
c. a second opening at the front end of the covering and defined by a lip having a size to receive the hand of the individual, wherein the lip has a securing means.

2. The leash mitt of claim 1 wherein the securing means is selected from the group consisting of a series of snaps, a fastener, a strap, a buckle, a series of buttons, a series of hooks, an elastic member, a tie, a clip, a bungee cord & cord lock, or a combination thereof.

3. The leash mitt of claim 2, wherein the securing means is secured or sewn into lip.

4. The leash mitt of claim 1, wherein the first pocket has a length ranging from about 10 inches to about 16 inches, and a height ranging from about 6 inches to about 10 inches.

5. The leash mitt of claim 1, further including an adjustable means disposed lengthwise on the outside surface or the inside surface for adjusting the length of the leash mitt, wherein the adjustable means is selected from the group consisting of a series of snaps, a fastener, a buckle, a button, a series of hooks, a clip, or a combination thereof.

6. The leash mitt of claim 1, wherein the recloseable member of the first opening is selected from the group consisting of: a zipper, a series of snaps, a fastener, a strap, a buckle, a trap-lock, a series of buttons, a series of hooks, an elastic member, a tie, a clip, a drawstring & cord lock, a hook-to-hook arrangement, a hook & loop arrangement, a bungee cord & cord lock, a magnet, a slide, a series of clips or a combination thereof.

7. The leash mitt of claim 1, wherein the leash mitt is made from a flexible material.

8. The leash mitt of claim 7, wherein the leash mitt is made from a material selected from the group consisting of: cotton, fleece, terry cloth, leather, nylon, down, polypropylene, wool, yarn, sheepskin, a synthetic material, an elastic material, or any combination thereof.

9. The leash mitt of claim 1, wherein the leash mitt is lined with an insulating material.

10. The leash mitt of claim 9, wherein insulating material is selected from the group consisting of: cotton, fleece, terry cloth, leather, nylon, down, polypropylene, wool, sheepskin, a synthetic material, an elastic material, or any combination thereof.

11. The leash mitt of claim 1, wherein the leash mitt is made from the same material or same piece of material, or from different pieces of different material.

12. The leash mitt of claim 1, further including a second pocket attached to the outside or inside surface of the leash mitt.

13. The leash mitt of claim 1, further including a reflective surface.

14. The leash mitt of claim 1, further including a stopper at the first opening, wherein the recloseable member closes a portion of the opening stopping at the stopper to thereby leaving a point of extrusion for the leash

15. A system for keeping an individual's hands warm while walking an animal with a retractable leash or lead, the system comprises:
a. a leash mitt to be worn over the hand that holds the leash or lead, the leash mitt comprises:
i. a covering having a front end, a back end, a top end, a bottom end, an outside surface and an inside surface, wherein the covering defines a first pocket to house the hand of an individual and a retractable leash or lead;
ii. a first opening at the bottom end, wherein the opening has a reclosableable member and has a size between about 6 inches and about 10 inches, wherein the recloseable member closes a portion of the opening to thereby leaving a point of extrusion for the leash;
iii. a second opening at the front end of the covering and defined by a lip having a size to receive the hand of the individual, wherein the lip has a securing means;
b. a non-leash mitt or glove to cover the hand of the individual that is not holding a leash or lead.

16. The system of claim 14, wherein the securing means is selected from the group consisting of a series of snaps, a fastener, a strap, a buckle, a series of buttons, a series of hooks, an elastic member, a tie, a clip, a series of clips or any combination thereof.

17. The system of claim 15, wherein the securing means is secured or sewn into lip.

18. The system of claim 14, wherein the first pocket has a length ranging from about 10 inches to about 16 inches, and a height ranging from about 6 inches to about 10 inches.

19. The system of claim 14, wherein the recloseable member of the first opening is selected from the group consisting of: a zipper, a series of snaps, a fastener, a strap, a buckle, a trap-lock, a series of buttons, a series of hooks, an elastic member, a tie, a clip, a drawstring & cord lock, a hook-to-hook arrangement, a hook & loop arrangement, a bungee cord & cord lock, a magnet, a slide, a strap, a series of clips or any combination thereof.

20. The system of claim 14, wherein the leash mitt and the non-leash mitt or glove are made from a flexible material.

21. The system of claim 14, wherein the leash mitt and non-leash mitt or glove is lined with an insulating material.

22. The system of claim 14, wherein the leash mitt and non-leash mitt or glove match in color, pattern or both.

23. The system of claim 14 wherein the leash mitt and non-leash mitt or glove includes a reflective surface.

24. The system of claim 14, further including a retractable leash that comprises:
a. a base having a device for retracting the leash and a grip, and
b. a leash having a first end that attaches to the retracting device, and a second end for attaching to a collar of the dog;

25. A system for keeping an individual's hands warm while walking an animal with a retractable leash or lead, the system comprises:
a. a leash mitt to be worn over the hand that holds the leash or lead, the leash mitt comprises:
i. a covering having a front end, a back end, a top end, a bottom end, an outside surface and an inside surface, wherein the covering defines a pocket to house the hand of an individual and a retractable leash or lead;
ii. a first opening at the bottom end, wherein the opening has a reclosableable member and has a size between about 6 inches and about 10 inches, wherein the recloseable member closes a portion of the opening to thereby leaving a point of extrusion for the leash;
iii. a second opening at the front end of the covering and defined by a lip having a size to receive the hand of the individual, wherein the lip has an elastic member as a securing means;
iv. a stopper or locking mechanism at the point of extrusion to prevent the recloseable member from unwanted re-opening;
b. a non-leash mitt or glove to cover the hand of the individual that is not holding a leash or lead.

26. A method of walking a dog with a retractable leash or lead with the system of claim 24, wherein the method comprises the steps of:
a. inserting an individual's hand into the pocket through the second opening;
b. inserting the retractable leash or lead into the first opening;
c. gripping the grip of the leash; and
d. extending the second end of the leash through the first opening;
e. engaging the recloseable member to essentially close the first opening, except for the point of extrusion of the leash; and
f. walking the dog.

27. The method of claim 26, wherein the method further comprises disconnecting and reconnecting the leash to the dog without removing the individual hand from the mitt.
